(19) United States
(12) Patent Application Publication
(10) Pub. No.: US 2025/0306739 A1
(43) Pub. Date: Oct. 2, 2025

(54) DATA ANALYSIS METHOD, READABLE MEDIUM, AND ELECTRONIC DEVICE

(71) Applicant: Beijing Volcano Engine Technology Co., Ltd., Beijing (CN)

(72) Inventors: Songming CHEN, Beijing (CN); Bingshu JIN, Beijing (CN); Sijie SHAN, Beijing (CN); Jian QIU, Beijing (CN); Xiangshu LI, Beijing (CN); Yinlong ZHU, Beijing (CN); Feng QIAN, Beijing (CN); Meitong YAN, Beijing (CN)

(21) Appl. No.: 19/097,293

(22) Filed: Apr. 1, 2025

(30) Foreign Application Priority Data
Apr. 1, 2024 (CN) 202410390398.8

(51) Int. Cl. G06F 3/0484; G06F 3/0482; G06T 11/20

(52) U.S. Cl. CPC G06F 3/0484; G06F 3/0482; G06T 11/206; G06T 2200/24

(57) ABSTRACT

The present disclosure relates to a data analysis method, readable medium, and electronic device. The method includes: displaying a data graph to be analyzed or data table to be analyzed in a first data analysis platform; in response to a trigger operation on a content displayed in the data graph or data table, displaying a data panel, and displaying, in the data panel, a function entry for jumping from the first data analysis platform to a second data analysis platform; and in response to a trigger operation on the function entry, jumping from the first data analysis platform to the second data analysis platform.

### CROSS-REFERENCE TO RELATED APPLICATION

The present application claims priority of the Chinese Patent Application No. 202410390398.8, filed on Apr. 1, 2024, and the disclosure of which is incorporated herein by reference in its entirety as part of the present application.

### TECHNICAL FIELD

The present disclosure relates to the field of computer technology, and in particular, to a data analysis method, a readable medium, and an electronic device.

### BACKGROUND

With the advent of the big data era, data in business scenarios is diverse and complex, and in order to mine meaningful information from the data, it is generally necessary to perform data analysis on the data in the business scenarios using a data analysis platform.

### SUMMARY

This summary is provided to introduce concepts in a simplified form that are described in detail in the following detailed description section. This summary section is not intended to identify key features or essential features of the claimed technical solution, nor is it intended to be used to limit the scope of the claimed technical solution.

At least one embodiment of the present disclosure provides a data analysis method, and the method includes:

displaying, in a first data analysis platform, a data graph to be analyzed or a data table to be analyzed;

in response to a trigger operation on a content displayed in the data graph or the data table, displaying a data panel, and displaying, in the data panel, a function entry for jumping from the first data analysis platform to a second data analysis platform; and

in response to a trigger operation on the function entry, jumping from the first data analysis platform to the second data analysis platform.

At least one embodiment of the present disclosure provides a data analysis apparatus, and the data analysis apparatus includes:

a first display module, configured to display a data graph to be analyzed or a data table to be analyzed in a first data analysis platform;

a second display module, configured to: in response to a trigger operation on a content displayed in the data graph or the data table, display a data panel, and display, in the data panel, a function entry for jumping from the first data analysis platform to a second data analysis platform; and

a jumping module, configured to: in response to a trigger operation on the function entry, jump from the first data analysis platform to the second data analysis platform.

At least one embodiment of the present disclosure provides a computer-readable medium having a computer program stored thereon, when the program is executed by a processing apparatus, the steps of the method according to any one of the first aspect are implemented.

At least one embodiment of the present disclosure provides an electronic device, and the electronic device includes:

a storage apparatus having a computer program stored thereon; and

a processing apparatus configured to execute the computer program in the storage apparatus to implement the steps of the method according to any one of the first aspect.

At least one embodiment of the present disclosure provides a computer program product including a computer program, when the computer program is executed by a processor, the steps of the method according to any one of the first aspect are implemented.

Through the above technical solutions, the function entry for jumping from the first data analysis platform to the second data analysis platform can be displayed when the trigger operation is performed on the data graph to be analyzed or data table to be analyzed in the first data analysis platform, and the second data analysis platform can be jumped to from the first data analysis platform when the trigger operation is performed on the function entry. Therefore, the data graph to be analyzed or data table to be analyzed can be analyzed through the second data analysis platform. In addition, since the function entry is displayed when the trigger operation is performed on the data graph to be analyzed or data table to be analyzed, the second data analysis platform can be jumped to by triggering the function entry without leaving or switching the first data analysis platform, thereby reducing the operational complexity of the user, and improving the data analysis efficiency and user experience.

Other features and advantages of the present disclosure will be described in detail in the following detailed description section.

### BRIEF DESCRIPTION OF DRAWINGS

The above and other features, advantages and aspects of various embodiments of the present disclosure will become more apparent with reference to the following detailed description and in conjunction with the drawings. Throughout the drawings, the same or similar reference numerals denote the same or similar elements. It should be understood that the drawings are schematic and that parts and elements are not necessarily drawn to scale. In the drawings:

FIG. 1 is a flowchart of a data analysis method according to an exemplary embodiment of the present disclosure;

FIG. 2 is a schematic diagram of displaying a data region according to an exemplary embodiment of the present disclosure;

FIG. 3 is a schematic diagram of displaying a function entry in a data panel according to an exemplary embodiment of the present disclosure;

FIG. 4 is a schematic diagram of displaying a function entry in a data panel according to an exemplary embodiment of the present disclosure;

FIG. 5 is a schematic diagram of displaying a function entry in a data panel according to an exemplary embodiment of the present disclosure;

FIG. 6 is a schematic diagram of displaying a function entry in a data panel according to an exemplary embodiment of the present disclosure;

FIG. 7 is a schematic diagram of displaying a function entry in a data panel according to an exemplary embodiment of the present disclosure;

FIG. 8 is a schematic diagram of displaying a function entry in a data panel according to an exemplary embodiment of the present disclosure;

FIG. 9 is a schematic diagram of displaying target content and a function entry in a data panel according to an exemplary embodiment of the present disclosure;

FIG. 10 is a schematic diagram of displaying target content in a data panel according to an exemplary embodiment of the present disclosure;

FIG. 11 is a schematic diagram of displaying target content in a data panel according to an exemplary embodiment of the present disclosure;

FIG. 12 is a schematic diagram of displaying target content in a data panel according to an exemplary embodiment of the present disclosure;

FIG. 13 is a schematic diagram of displaying target content in a data panel according to an exemplary embodiment of the present disclosure;

FIG. 14 is a schematic diagram of displaying target content in a data panel according to an exemplary embodiment of the present disclosure;

FIG. 15 is a structural block diagram of a data analysis apparatus according to an exemplary embodiment of the present disclosure; and

FIG. 16 is a schematic structural diagram of an electronic device according to an exemplary embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are only used for exemplary purposes and are not used to limit the scope of the present disclosure.

It should be understood that various steps described in the method implementations of the present disclosure can be executed in different orders and/or executed in parallel. In addition, the method implementations may include additional steps and/or omit performing the illustrated steps. The scope of the present disclosure is not limited in this regard.

The term “include/include” and its variants as used herein are open-ended inclusions, that is, “include/include but not limited to”. The term “based on” is “at least partially based on”. The term “one embodiment” means “at least one embodiment”; the term “another embodiment” means “at least one other embodiment”; the term “some embodiments” means “at least some embodiments”. Relevant definitions of other terms will be given in the following description.

It should be noted that concepts such as “first” and “second” mentioned in the present disclosure are only used to distinguish different apparatuses, modules or units, and are not used to limit the order or interdependence of functions performed by these apparatuses, modules or units.

It should be noted that the modifiers “one” and “a plurality of” mentioned in the present disclosure are illustrative rather than restrictive, and those skilled in the art should understand that unless otherwise clearly indicated in the context, they should be understood as “one or more”.

The names of messages or information exchanged between apparatuses in the implementations of the present disclosure are only used for illustrative purposes, and are not used to limit the scope of these messages or information.

It can be understood that before using the technical solutions disclosed in the embodiments of the present disclosure, the user shall be informed of the type, scope of use, use scenarios, etc. of the personal information involved in the present disclosure in an appropriate manner in accordance with relevant laws and regulations, and the user's authorization shall be obtained.

For example, in response to receiving an active request from a user, prompt information is sent to the user, to explicitly prompt the user that an operation requested to be performed will require access to and use of the user's personal information. Thus, the user can independently choose whether to provide personal information to software or hardware such as an electronic device, an application, a server or a storage medium that performs the operations of the technical solutions of the present disclosure, according to the prompt information.

As an optional but non-limiting implementation, the manner of sending prompt information to the user in response to receiving the active request from the user may be, for example, a pop-up window, and the prompt information may be presented in text in the pop-up window. In addition, the pop-up window may also include a selection control for the user to choose between “agree” or “disagree” to provide the personal information to the electronic device.

It can be understood that the above process of notifying and acquiring the user's authorization is only illustrative and does not constitute a limitation on the implementations of the present disclosure, and other manners that meet relevant laws and regulations may also be applied to the implementations of the present disclosure.

At the same time, it can be understood that the data involved in the technical solutions (including but not limited to the data itself, the acquisition or use of the data) should comply with the requirements of corresponding laws, regulations and related regulations.

As mentioned in the background art, with the advent of the big data era, data in business scenarios is diverse and complex, and in order to mine meaningful information from the data, it is generally necessary to perform data analysis on the data in the business scenarios using a data analysis platform.

Since a single data analysis platform in the related art has limited analysis dimensions for data, when data needs to be analyzed in different dimensions, it is necessary to switch between different data analysis platforms, which increases the operational complexity of the user.

Exemplarily, the data to be analyzed is target data of a target application. When the target data needs to be analyzed from a product operation dimension, a data analysis platform A for analyzing the target data from the product operation dimension needs to be opened first, and the target data is imported into the data analysis platform A. When the target data needs to be analyzed from a content operation dimension, the data analysis platform A needs to be exited, a data analysis platform B for performing data analysis on the target data from the content operation dimension is opened, and the target data is imported into the data analysis platform B. Therefore, when performing data analysis on the target data in the product operation dimension and the content operation dimension, complex operations are required to switch between the data analysis platform A and the data analysis platform B, which reduces the data analysis efficiency.

In order to overcome the above technical problems, the inventor first proposes to embed a function module for jumping to other data analysis platforms in a platform page of a data analysis platform. However, it is found in practical use that since the function module is embedded in the platform page, but data analysis occurs in a data analysis page, when other data analysis platforms need to be used for data analysis, a data analysis page needs to be switched to the platform page first, and then the other data analysis platforms are jumped to by triggering the function module for jumping to the other data analysis platforms. In this way, the improvement in data analysis efficiency is not obvious.

In view of this, the present disclosure provides a data analysis method, apparatus, readable medium, electronic device and program product to solve the above technical problems.

The embodiments of the present disclosure will be further explained and illustrated below with reference to the drawings.

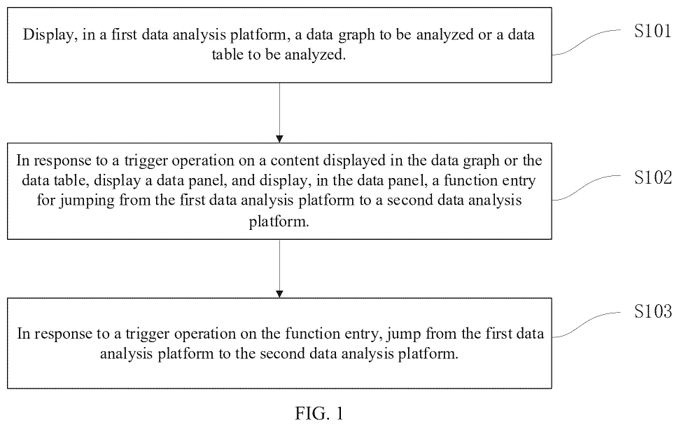

FIG. 1 is a flowchart of a data analysis method according to an exemplary embodiment of the present disclosure. Referring to FIG. 1, the method may include the following steps:

S101: display, in a first data analysis platform, a data graph to be analyzed or a data table to be analyzed.

The first data analysis platform may be a growth analysis platform capable of achieving business growth, or an attribution analysis platform capable of achieving attribution of business problems, or other analysis platforms, which is not limited in the embodiments of the present disclosure.

Exemplarily, when the first data analysis platform is a growth analysis platform, after the growth analysis platform is opened, a growth analysis platform page including a plurality of analysis function modules may be displayed. By clicking on any of the analysis function module in the growth analysis platform page, such as clicking on an event analysis module, an event analysis page is displayed, and after data configuration is performed through a data configuration control in the event analysis page, the data graph to be analyzed or data table to be analyzed is displayed.

S102: in response to a trigger operation on a content displayed in the data graph or the data table, display a data panel, and display, in the data panel, a function entry for jumping from the first data analysis platform to a second data analysis platform.

It should be understood that in order to reflect a distribution trend between data, the data is generally displayed in the data graph in the form of data points or data regions. In order to present the data intuitively, the data is generally displayed in the data table in a structured arrangement. Therefore, the trigger operation on the content displayed in the data graph may be a trigger operation on the data point or the data region, and the trigger operation on the content displayed in the data table may be a trigger operation on the data item.

It should be understood that this is only a schematic illustration and does not constitute a limitation to the solution. Exemplarily, in some data tables, in order to perform additional processing on the data in the data table, some preset interaction controls may also be displayed in the data table. Therefore, the trigger operation on the content displayed in the data table may also be a trigger operation on the interaction control.

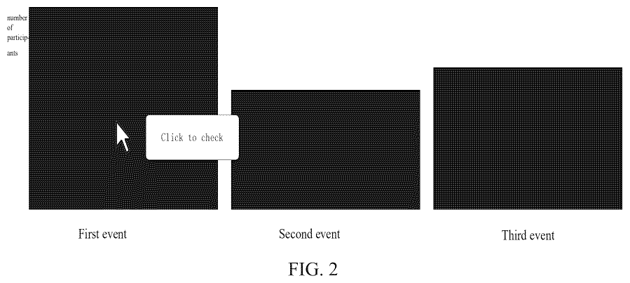

It should be understood that the data region refers to an area formed by data in the data graph, and is a representation of the data in the data graph. Exemplarily, in an event analysis page, data configured through a data configuration control includes: the number of participants in a first event, the number of participants in a second event, and the number of participants in a third event. When the data in the event analysis scenario is displayed in the data graph in the form of data regions, a data graph corresponding to the event analysis scenario may be as shown in FIG. 2, where a rectangular area in the data graph is the data region. Specifically, a rectangular area corresponding to the first event is the number of participants in the first event, a rectangular area corresponding to the second event is the number of participants in the second event, and a rectangular area corresponding to the third event is the number of participants in the third event.

It should be understood that one or more function entries may be displayed in the data panel, which is not limited in the embodiments of the present disclosure. Correspondingly, when one function entry is displayed in the data panel, there is one second data analysis platform; when a plurality of function entries are displayed in the data panel, there are a plurality of second data analysis platforms.

When there are a plurality of second data analysis platforms, each of the second data analysis platforms may have the same or different analysis dimensions for the data graph or the data table. When each of the second data analysis platforms has the same analysis dimension for the data graph or the data table, each of the second data analysis platforms may have different analysis manners for the data graph or the data table, thereby increasing the degree of freedom of choice of the user and improving the user experience.

S103: in response to a trigger operation on the function entry, jump from the first data analysis platform to the second data analysis platform.

Jumping from the first data analysis platform to the second data analysis platform may be directly jumping to a home page of the second data analysis platform, that is, a platform page of the second data analysis platform. Alternatively, it may be directly jumping to a data analysis page in the second data analysis platform, and displaying, in the data analysis page of the second data analysis platform, the data graph or data table to be analyzed displayed in the first data analysis platform.

Through the above technical solutions, the function entry for jumping from the first data analysis platform to the second data analysis platform may be displayed when the trigger operation is performed on the data graph to be analyzed or data table to be analyzed in the first data analysis platform, and the second data analysis platform may be jumped to from the first data analysis platform when the trigger operation is performed on the function entry. Therefore, the data graph to be analyzed or data table to be analyzed can be analyzed through the second data analysis platform. In addition, since the function entry may be displayed when the trigger operation is performed on the data graph to be analyzed or data table to be analyzed, the second data analysis platform may be jumped to by triggering the function entry without closing the first data analysis platform or switching the display page, thereby reducing the operational complexity of jumping from the first data analysis platform to the second data analysis platform, and improving the data analysis efficiency and user experience.

In a possible implementation, in response to the trigger operation on the content displayed in the data graph, displaying the data panel, and displaying, in the data panel, the function entry for jumping from the first data analysis platform to the second data analysis platform may include:

in response to the trigger operation on the data point or the data region in the data graph,

displaying the data panel, and displaying a first interactive control in the data panel; and in response to the trigger operation on the first interaction control, displaying, in the data panel, the function entry for jumping from the first data analysis platform to the second data analysis platform.

The trigger operation on the data point or the data region in the data graph may be performing a hover operation, a touch-and-hold operation or a click operation on the data point or the data region in the data graph, and the trigger operation on the first interaction control may be performing a hover operation, a touch-and-hold operation or a click operation on the first interaction control, which is not limited in the embodiments of the present disclosure.

Exemplarily, the trigger operation on the data point in the data graph may be performing a hover operation on the data point, and the trigger operation on the first interaction control may be performing a click operation on the first interaction control. Correspondingly, in response to the trigger operation on the content displayed in the data graph, displaying the data panel, and displaying, in the data panel, the function entry for jumping from the first data analysis platform to the second data analysis platform may be: when a mouse is hovered over any data point in the data graph, displaying the data panel, and displaying the first interaction control in the data panel, and clicking the first interaction control to display the function entry in the data panel. Alternatively, it may be: when a mouse is hovered over any data region in the data graph, displaying the data panel, and displaying the first interaction control in the data panel, and clicking the first interaction control to display the function entry in the data panel.

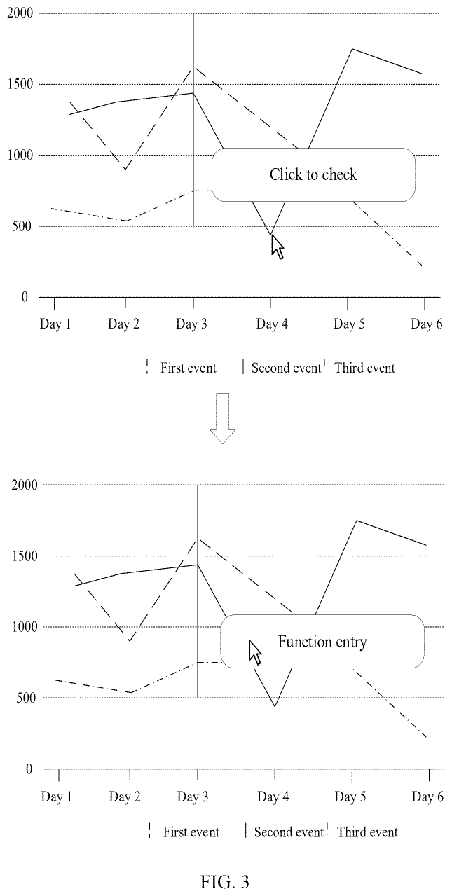

Exemplarily, in the event analysis page, data configured through the data configuration control includes: indicator values of a page access indicator of a first event in an analysis period, indicator values of a page access indicator of a second event in an analysis period, and indicator values of a page access indicator of a third event in an analysis period. After the data configuration is completed, the configured data is displayed in the data graph in the form of data points, as shown in FIG. 3. When a mouse is hovered over a data point corresponding to an indicator value of the second event on the day 4, a data panel is displayed, and a first interaction control “click to check” is displayed in the data panel, and the function entry is displayed in the data panel by clicking “click to check”.

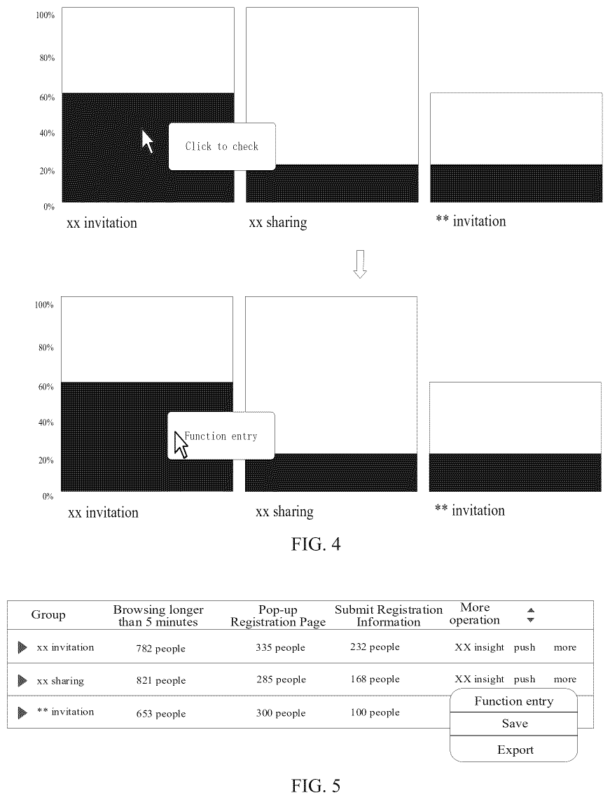

Exemplarily, in the event analysis page, data configured through the data configuration control includes: a proportion of people accessing a target page in a “xx invitation” way, a proportion of people accessing the target page in a “xx sharing” way, and a proportion of people accessing the target page in a “** invitation” way. After the data configuration is completed, the configured data is displayed in the data graph in the form of data regions, as shown in FIG. 4. When a mouse is hovered over a data region corresponding to “xx invitation”, a data panel is displayed, and a first interaction control “click to check” is displayed in the data panel, and the function entry is displayed in the data panel by clicking “click to check”.

After the data configuration is completed through the data configuration control, whether the data is displayed in the data graph in the form of data points or in the form of data regions may be set according to actual conditions, which is not limited in the embodiments of the present disclosure. Exemplarily, a style selection page may be displayed after the data configuration is completed, and the style selection page is displayed with a selection control for selecting a display style of data in the data graph. In response to a trigger operation on a target selection control, the data is displayed in the data graph in the corresponding form.

It should be understood that since the data graph generally reflects a distribution trend between data, the data information corresponding to each data point or data region may not be intuitively seen from the data graph. Therefore, when performing the trigger operation on the data point or the data region, the user may only want to view the data information corresponding to the data point or the data region. Therefore, in order to avoid the interference of the display of the function entry on the user's viewing of the data information, in this embodiment, when performing the trigger operation on the data point or the data region, the function entry is not displayed in the data panel, but the function entry is displayed after performing the trigger operation on the first interaction control in the data panel, thereby further improving the user experience.

In a possible implementation, in response to the trigger operation on the content displayed in the data table, displaying the data panel, and displaying, in the data panel, the function entry for jumping from the first data analysis platform to the second data analysis platform may include:

in response to the trigger operation on the data item in the data table or the second interaction control, displaying the data panel, and displaying, in the data panel, the function entry for jumping from the first data analysis platform to the second data analysis platform.

The data panel may be displayed when performing the trigger operation on any second interaction control in the data table, or the data panel may be displayed when performing the trigger operation on a designated second interaction control in the data table, which is not limited in the embodiments of the present disclosure.

The trigger operation on the data item in the data table or the second interaction control may be performing a hover operation, a touch-and-hold operation or a click operation on the data item or the second interaction control, which is not limited in the embodiments of the present disclosure.

Exemplarily, the trigger operation on the second interaction control in the data table may be performing a click operation on the second interaction control. Correspondingly, in response to the trigger operation on the content displayed in the data table, displaying the data panel, and displaying, in the data panel, the function entry for jumping from the first data analysis platform to the second data analysis platform may be: when the second interaction control in the data table is clicked, displaying the data panel, and displaying the function entry in the data panel.

Exemplarily, in the event analysis page, data configured through the data configuration control includes: the number of people who access a target page in a “xx invitation” way and perform a preset action on the target page, the number of people who access the target page in a “xx sharing” way and perform a preset action on the target page, and the number of people who access the target page in a “** invitation” way and perform a preset action on the target page. After the data configuration is completed, the configured data is displayed in the form of data tables, as shown in FIG. 5. When a second interaction control “more” corresponding to “xx sharing” is clicked, a data panel is displayed, and the function entry is displayed in the data panel.

It should be understood that since the data table can present the data information intuitively, when performing the trigger operation on the data item or the second interaction control, the user would not just want to view the data information corresponding to the data item or the second interaction control. Therefore, after performing the trigger operation on the data item or the second interaction control, the function entry may be directly displayed in the data panel, thereby improving the user experience.

In a possible implementation, the content analysis method may further include:

displaying, in the data panel, a target content related to the display content, the target content including data information corresponding to the display content and/or a function option for performing data processing on data information corresponding to the display content.

The target content displayed in the data panel is determined according to actual conditions, which is not limited in the embodiments of the present disclosure.

Since the data graph generally reflects the distribution trend between data, the data information corresponding to each data point or data region may not be intuitively seen from the data graph. Therefore, when the display content is the data point or data region in the data graph, the data information corresponding to the data point or data region and the function option for performing data processing on the data information may be displayed in the data panel. Correspondingly, in response to the trigger operation on the content displayed in the data graph, displaying the data panel, and displaying, in the data panel, the function entry for jumping from the first data analysis platform to the second data analysis platform may be: when a mouse is hovered over any data point in the data graph, displaying the data panel, and displaying the data information corresponding to the data point and the first interaction control in the data panel, and clicking the first interaction control to display the data information, the function entry and the function option in the data panel. Alternatively, it may be: when a mouse is hovered over any data region in the data graph, displaying the data panel, and displaying, in the data panel, the data information corresponding to the data region and the first interaction control, and clicking the first interaction control to display the data information, the function entry and the function option in the data panel.

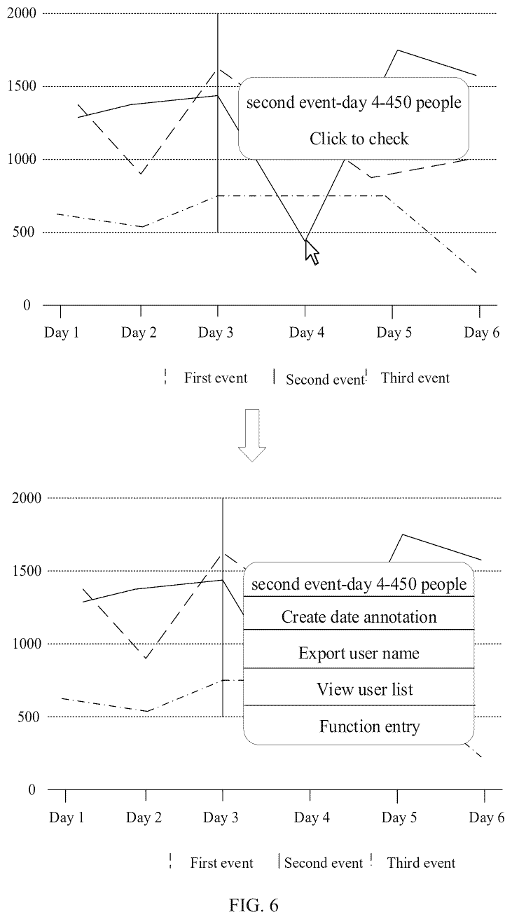

Exemplarily, continuing with the example where the data configured in the event analysis page through the data configuration control includes: the indicator values of the page access indicator of the first event in the analysis period, the indicator values of the page access indicator of the second event in the analysis period, and the indicator values of the page access indicator of the third event in the analysis period. When the mouse is hovered over the data point corresponding to the indicator value of the second event on the day 4, the data panel is displayed, and the data information “second event-day 4-450 people” corresponding to the data point and the first interaction control “click to check” are displayed in the data panel. By clicking “click to check”, the data information “second event-day 4-450 people”, the function entry and the function option “create date annotation”, “export user name” and “view user list” are displayed in the data panel, as shown in FIG. 6.

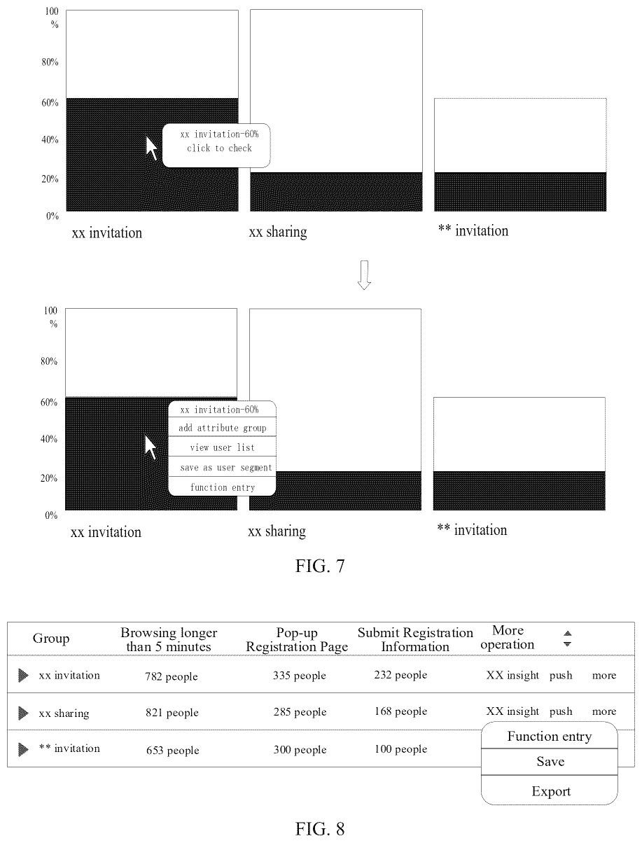

Exemplarily, continuing with the example where the data configured in the event analysis page through the data configuration control includes: the proportion of people accessing the target page in the “xx invitation” way, the proportion of people accessing the target page in the “xx sharing” way, and the proportion of people accessing the target page in the “** invitation” way. When the mouse is hovered over the data region corresponding to “xx invitation”, the data panel is displayed, and the data information “xx invitation-60%” and the first interaction control “click to check” are displayed in the data panel. By clicking “click to check”, the data information “xx invitation-60%”, the function entry and the function option “add attribute group”, “view user list” and “save as user segment” are displayed in the data panel, as shown in FIG. 7.

Since the data table can present the data information intuitively, the function option may be displayed in the data panel when the display content is the data item or the second interaction control. Correspondingly, in response to the trigger operation on the content displayed in the data table, displaying the data panel, and displaying, in the data panel, the function entry for jumping from the first data analysis platform to the second data analysis platform may be: when the data item or the second interaction control in the data table is clicked, displaying the data panel, and displaying the function entry and the function option in the data panel.

Exemplarily, continuing with the example where the data configured in the event analysis page through the data configuration control includes: the number of people who access the target page in the “xx invitation” way and perform the preset action on the target page, the number of people who access the target page in the “xx sharing” way and perform the preset action on the target page, and the number of people who access the target page in the “** invitation” way and perform the preset action on the target page. When the second interaction control “more” corresponding to “xx sharing” is clicked, the data panel is displayed, and the function entry and the function option “save and export” are displayed in the data panel, as shown in FIG. 8.

The data information and the function option displayed in the data panel may be determined according to actual conditions, which is not limited in the embodiments of the present disclosure. Exemplarily, the displayed data information may include a data value, a data name, a data type, or a data priority, etc. The displayed function option may include a save function, an export function, a create annotation function, or an analysis function, etc.

The display manner or display style of the target content and the function entry in the data panel may be determined according to actual conditions, which is not limited in the embodiments of the present disclosure.

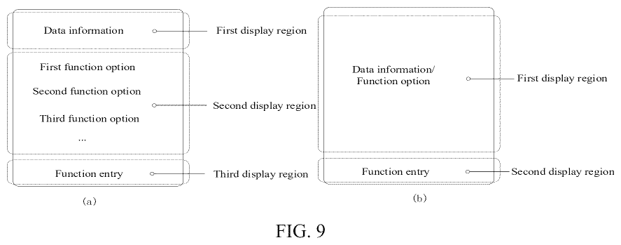

Exemplarily, when the target content includes the data information and the function option, the data panel may be divided into three display regions, the data information is displayed in a first display region of the data panel, the function option is displayed in a second display region of the data panel, and the function entry is displayed in a third display region of the data panel, as shown in FIG. 9(a). Alternatively, when the target content includes the data information or the function option, the data panel may be divided into two display regions, the data information or the function option is displayed in the first display region of the data panel, and the function entry is displayed in the second display region of the data panel, as shown in FIG. 9(b).

In a possible implementation, when the display contents in the data graph or the data table are different, target contents displayed in the data panel are different; and/or, when the trigger operation is performed on different display contents in the data graph or the data table, the target content displayed in the data panel are different.

Exemplarily, as shown in FIG. 6 and FIG. 7, the target content displayed in FIG. 6 includes data information “second event-day 4-450” and function options “create date annotation”, “export user name” and “view user list”. The target content displayed in FIG. 7 includes data information “xx invitation-60%” and function options “add attribute group”, “view user list” and “save as user segment”.

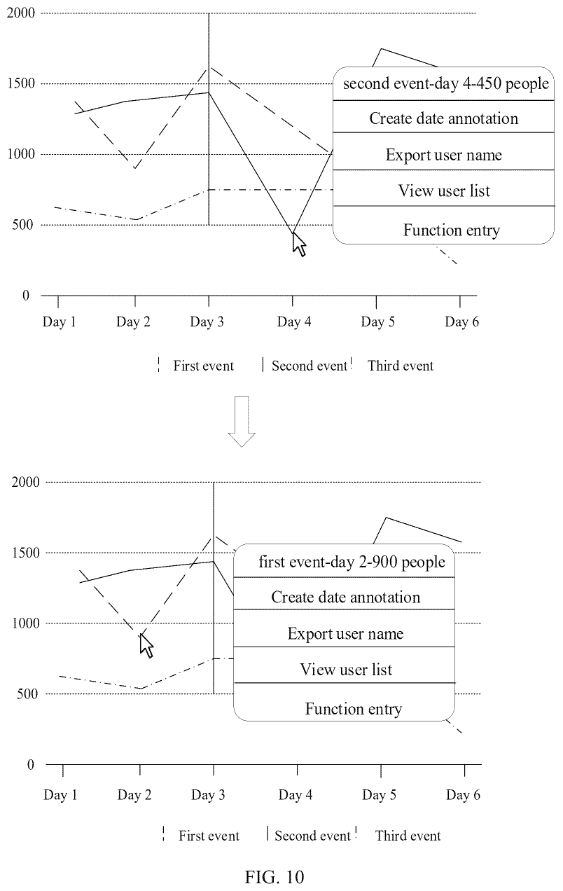

Exemplarily, continuing with the example where the data configured in the event analysis page through the data configuration control includes: the indicator values of the page access indicator of the first event in the analysis period, the indicator values of the page access indicator of the second event in the analysis period, and the indicator values of the page access indicator of the third event in the analysis period. When the mouse is hovered over the data point corresponding to the indicator value of the second event on the day 4, the target content displayed in the data panel includes the data information “second event-fourth day-450 people”, the function entry and the function option “create date annotation”, “export user name” and “view user list”. When the mouse is hovered over the data point corresponding to the indicator value of the first event on the second day, the target content displayed in the data panel includes the data information “first event-day 2-900 people”, the function entry and the function option “create date annotation”, “export user name” and “view user list”, as shown in FIG. 10.

In a possible implementation, the displaying, in the data panel, the target content related to the display content may include:

displaying, in the data panel, the data information corresponding to the display content and the function option for performing the data processing on the data information corresponding to the display content; or displaying, in the data panel, at least one selected from the group of following: the data information corresponding to the display content, the function option for performing the data processing on the data information corresponding to the display content, the comparison information of the data information corresponding to the display content in the time dimension; or displaying, in the data panel, at least one selected from the group of following: the data information corresponding to the display content, the function option for performing the data processing on the data information corresponding to the display content, the comparison information of the data information corresponding to the display content in the time dimension, or the at least one piece of sub-dimensional information of the data information corresponding to the display content in the target data dimension, where the target data dimension is the data dimension corresponding to the data information.

The target content displayed in the data panel may be determined according to an actual analysis scenario, which is not limited in the embodiments of the present disclosure.

Exemplarily, in an analysis scenario where the number of analysis indicators is less than the first preset indicator number, the display content in the data panel may include the data information and the function option. As shown in FIG. 11, the data information corresponding to a certain data point, for example, a data indicator “overall conversion proportion” and a corresponding data indicator value “25.6%”, may be displayed in a first display region of the data panel, and function options such as “export user name” and “view user list” are displayed in a second display region of the data panel.

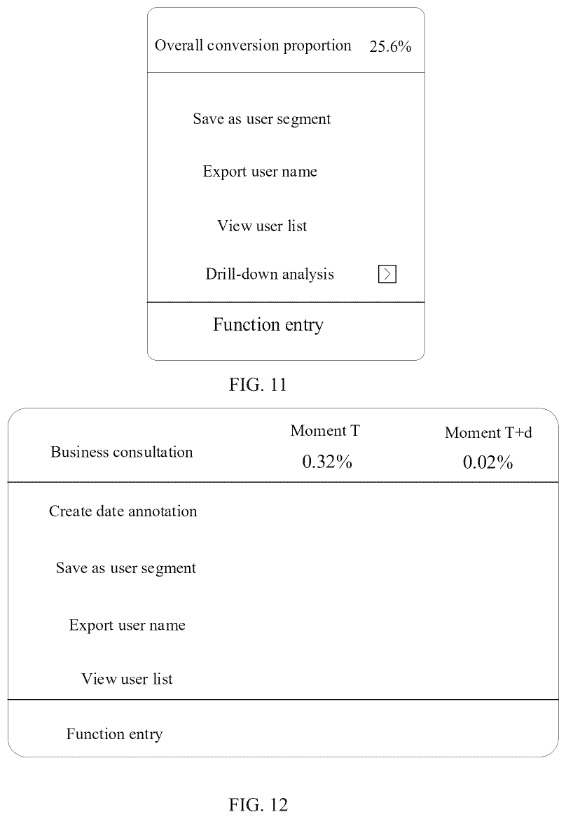

Exemplarily, in an analysis scenario where the number of analysis indicators is greater than the first preset indicator number and less than the second preset indicator number, the display content in the data panel may include the data information, the function option, and the comparison information. As shown in FIG. 12, the data information and the comparison information corresponding to a certain data point may be displayed in the first display region of the data panel. For example, the data information may include an event name “business consultation”. The comparison information may include a data value “0.32%” of the “business consultation” at moment T, and a data value “0.02%” of the “business consultation” at moment T+d. The function options such as “create date annotation” and “view user list” may be displayed in the second display region of the data panel.

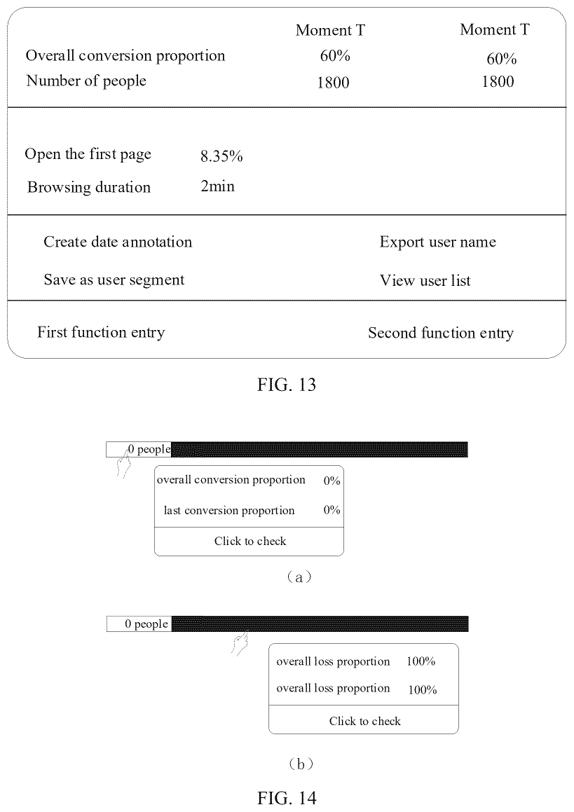

Exemplarily, in an analysis scenario where the number of analysis indicators is greater than the second preset indicator number, the display content in the data panel may include the data information, the function option, the comparison information, and the sub-dimensional information. As shown in FIG. 13, the data information and the comparison information corresponding to a certain data point may be displayed in the first display region of the data panel. For example, data indicators “overall conversion proportion” and “number of people”, the comparison information may include a data value “60%” of the “overall conversion proportion” at moment T, a data value “1800” of the “number of people” at moment T, a data value “60%” of the “overall conversion proportion” at moment T+d, and a data value “1800” of the “number of people” at moment T+d. The sub-dimensional information may be displayed in the second display region of the data panel. For example, the sub-dimensional information may include a first sub-dimensional indicator “open the first page” and a second sub-dimensional indicator “browsing duration” corresponding to the data indicator “number of people”, an indicator value “8.35%” of the first sub-dimensional indicator, and an indicator value “2 min” of the second sub-dimensional indicator. The function options such as “create date annotation” and “view user list” may be displayed in the third display region of the data panel.

In a possible implementation, the displaying, in the data panel, the target content related to the display content may include:

in response to a trigger operation on a first display content, displaying a first target content related to the first display content; and in response to a trigger operation on a second display content, displaying a second target content related to the second display content, where the first display content is different from the second display content.

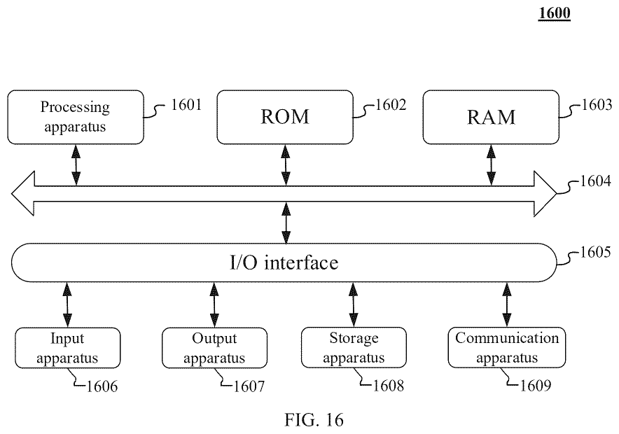

Exemplarily, when a conversion analysis module in the growth analysis platform page is clicked, a conversion analysis page is displayed, and data configuration is performed in the conversion analysis page based on the data configuration control, to obtain a funnel chart as shown in FIG. 16. When a mouse is hovered over a first data region in the funnel chart, a data panel is displayed, and data information corresponding to the first data region: an overall conversion proportion of 0% and a last conversion proportion of 0% is displayed in the data panel, as shown in FIG. 14(a). When a mouse is hovered over a second data region in the funnel chart, a data panel is displayed, and data information corresponding to the data point: an overall loss proportion of 100% and a last loss proportion of 100% is displayed in the data panel, as shown in FIG. 14(b).

In a possible implementation, the target content and the function entry displayed in the data panel are displayed through the identical preset display style.

The preset display style may be determined according to actual conditions, which is not limited in the embodiments of the present disclosure.

Exemplarily, the preset display style may be: text in the target content is displayed in a unified font and size, data in the target content is displayed in a unified font and size, there is a fixed line spacing between different lines in the target content, there is a fixed line height between different lines in the target content, and/or the target content is displayed in a preset content display order.

Through the above technical solutions, the target content and the function entry in different scenarios can have the same display style, so that the data panels in different scenarios have the same visual style, which in turn enables users to become familiar with the display content in the data panel more quickly and improve the operation efficiency of users.

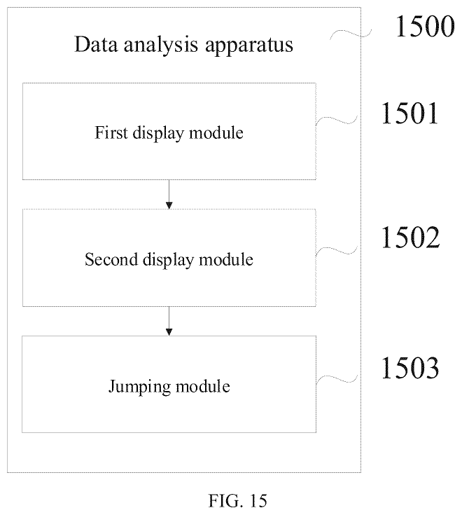

Based on the same concept, the embodiments of the present disclosure further provide a data analysis apparatus, which may be as shown in FIG. 15 and includes:

a first display module 1501, configured to display a data graph to be analyzed or a data table to be analyzed in a first data analysis platform;

a second display module 1502, configured to, in response to a trigger operation on a content displayed in the data graph or the data table, display a data panel, and display, in the data panel, a function entry for jumping from the first data analysis platform to a second data analysis platform; and

a jumping module 1503, configured to, in response to a trigger operation on the function entry, jump from the first data analysis platform to the second data analysis platform.

Through the above data analysis apparatus, the function entry for jumping from the first data analysis platform to the second data analysis platform may be displayed when the trigger operation is performed on the data graph to be analyzed or data table to be analyzed in the first data analysis platform, and the second data analysis platform may be jumped to from the first data analysis platform when the trigger operation is performed on the function entry. Therefore, the data graph to be analyzed or data table to be analyzed may be analyzed through the second data analysis platform. In addition, since the function entry is displayed when the trigger operation is performed on the data graph to be analyzed or data table to be analyzed, the second data analysis platform may be jumped to by triggering the function entry without leaving or switching the first data analysis platform, thereby reducing the operational complexity of the user, and improving the data analysis efficiency and user experience.

In a possible implementation, the second display module 1502 may include:

a first display unit, configured to, in response to the trigger operation on the data point or the data region in the data graph, display the data panel, and display a first interaction control in the data panel; and

a second display unit, configured to, in response to the trigger operation on the first interaction control, display, in the data panel, the function entry for jumping from the first data analysis platform to the second data analysis platform.

In a possible implementation, the second display module 1502 may include:

a third display unit, configured to, in response to the trigger operation on the data item in the data table or the second interaction control, display the data panel, and display, in the data panel, the function entry for jumping from the first data analysis platform to the second data analysis platform.

In a possible implementation, the data analysis apparatus 1500 may further include:

a third display module, configured to display, in the data panel, a target content related to the

display content, the target content including data information corresponding to the display content and/or a function option for performing data processing on data information corresponding to the display content.

In a possible implementation, when the display contents in the data graph or the data table are different, the target content displayed in the data panel are different; and/or when the trigger operation is performed on different display content in the data graph or the data table, the target contents displayed in the data panel are different.

In a possible implementation, the third display module may include:

a fourth display unit, configured to display, in the data panel, the data information corresponding to the display content and the function option for performing the data processing on the data information corresponding to the display content; or

a fifth display unit, configured to display, in the data panel, at least one selected from the group of following: the data information corresponding to the display content, the function option for performing the data processing on the data information corresponding to the display content, comparison information of the data information corresponding to the display content in a time dimension; or

a sixth display unit, configured to display, in the data panel, at least one selected from the group of following: the data information corresponding to the display content, the function option for performing the data processing on the data information corresponding to the display content, comparison information of the data information corresponding to the display content in a time dimension, or at least one piece of sub-dimensional information of the data information corresponding to the display content in a target data dimension, where the target data dimension is a data dimension corresponding to the data information.

In a possible implementation, the third display module may include:

a sixth display unit, configured to display first target content related to first display content in response to a trigger operation on the first display content; and

a sixth display unit, configured to display second target content related to second display content in response to a trigger operation on the second display content, where the first display content is different from the second display content.

In a possible implementation, the target content and the function entry displayed in the data panel are displayed through the identical preset display style.

Based on the same concept, an embodiment of the present disclosure further provides a computer-readable medium having a computer program stored thereon, when the program is executed by a processing apparatus, the steps of any one of the above data analysis methods are implemented.

Based on the same concept, an embodiment of the present disclosure further provides an electronic device, which may include:

a storage apparatus having a computer program stored thereon; and

a processing apparatus configured to execute the computer program in the storage apparatus to implement the steps of any one of the above data analysis methods.

Based on the same concept, an embodiment of the present disclosure further provides a computer program product including a computer program, when the computer program is executed by a processor, the steps of any one of the above data analysis methods are implemented.

Reference is made to FIG. 16 below, which illustrates a schematic structural diagram of an electronic device 1600 suitable for implementing an embodiment of the present disclosure. The terminal device in the embodiment of the present disclosure may include, but is not limited to, mobile terminals such as a mobile phone, a notebook computer, a digital broadcast receiver, a PDA (Personal Digital Assistant), a PAD (tablet computer), a PMP (Portable Multimedia Player), a vehicle-mounted terminal (e.g., a vehicle navigation terminal), and fixed terminals such as a digital TV, a desktop computer, and the like. The electronic device shown in FIG. 16 is only an example, and should not bring any limitation to the function and scope of use of the embodiments of the present disclosure.

As shown in FIG. 16, the electronic device 1600 may include a processing apparatus (e.g., a central processing unit, a graphics processing unit, etc.) 1601, which may perform various appropriate actions and processes according to a program stored in a read-only memory (ROM) 1602 or a program loaded from a storage apparatus 1608 into a random-access memory (RAM) 1603. The RAM 1603 further stores various programs and data required for the operation of the electronic device 1600. The processing apparatus 1601, the ROM 1602, and the RAM 1603 are connected to each other through a bus 1604. An input/output (I/O) interface 1605 is also connected to the bus 1604.

Generally, the following apparatuses may be connected to the I/O interface 1605: an input apparatus 1606 including, for example, a touchscreen, a touchpad, a keyboard, a mouse, a camera, a microphone, an accelerometer, a gyroscope, etc.; an output apparatus 1607 including, for example, a liquid crystal display (LCD), a speaker, a vibrator, etc.; a storage apparatus 1608 including, for example, a magnetic tape, a hard disk, etc.; and a communication apparatus 1609. The communication apparatus 1609 may allow the electronic device 1600 to perform wireless or wired communication with other devices to exchange data. Although FIG. 16 shows the electronic device 1600 having various apparatuses, it should be understood that it is not required to implement or have all of the illustrated apparatuses. More or fewer apparatuses may alternatively be implemented or provided.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium. The computer program includes program codes for executing the method shown in the flowchart. In such an embodiment, the computer program may be downloaded and installed from a network through the communication apparatus 1609, or installed from the storage apparatus 1608, or installed from the ROM 1602. When the computer program is executed by the processing apparatus 1601, the above-mentioned functions defined in the method of the embodiment of the present disclosure are executed.

It should be noted that the above computer-readable medium of the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, apparatus, or device, or any combination of the above. More specific examples of the computer-readable storage medium may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, and computer-readable program codes are carried in the data signal. This propagated data signal may take a variety of forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program for use by or in combination with an instruction execution system, apparatus, or device. The program codes contained on the computer-readable medium may be transmitted by any suitable medium, including but not limited to: a wire, an optical cable, RF (radio frequency), etc., or any suitable combination of the above.

In some implementations, communication may be performed using any currently known or future-developed network protocol such as HTTP (HyperText Transfer Protocol), and may be interconnected with digital data communication (e.g., a communication network) in any form or medium. Examples of the communication network include a local area network (“LAN”), a wide area network (“WAN”), an internetwork (e.g., the Internet), and a peer-to-peer network (e.g., an ad hoc peer-to-peer network), as well as any currently known or future-developed network.

The above computer-readable medium may be included in the above electronic device; or it may exist alone without being assembled into the electronic device.

The above computer-readable medium carries one or more programs. When the one or more programs are executed by the electronic device, the electronic device is caused to: display, in a first data analysis platform, a data graph to be analyzed or a data table to be analyzed; in response to a trigger operation on a content displayed in the data graph or the data table, display a data panel, and display, in the data panel, a function entry for jumping from the first data analysis platform to a second data analysis platform; and in response to a trigger operation on the function entry, jump from the first data analysis platform to the second data analysis platform.

Computer program codes for performing the operations of the present disclosure may be written in one or more programming languages or a combination thereof. The above programming languages include object-oriented programming languages such as Java, Smalltalk, C++, and also include conventional procedural programming languages such as the “C” language or similar programming languages. The program code may be executed entirely on the user's computer, partly on the user's computer, as a stand-alone software package, partly on the user's computer and partly on a remote computer, or entirely on the remote computer or server. In the case of the remote computer, the remote computer may be connected to the user's computer through any kind of network, including a local area network (LAN) or a wide area network (WAN), or may be connected to an external computer (for example, connected via the Internet using an Internet service provider).

The flowcharts and block diagrams in the drawings illustrate possible implementation architectures, functions, and operations of the system, method, and computer program product according to various embodiments of the present disclosure. In this regard, each block in the flowcharts or block diagrams may represent a module, a program segment, or a part of code, and the module, the program segment, or the part of code contains one or more executable instructions for implementing a specified logical function. It should also be noted that, in some alternative implementations, the functions marked in the blocks may also occur in a different order than the order marked in the drawings. For example, two blocks shown one after another may actually be executed substantially in parallel, and they may sometimes be executed in a reverse order, depending on the functions involved. It should also be noted that each block in the block diagrams and/or flowcharts, and a combination of blocks in the block diagrams and/or flowcharts, may be implemented by a dedicated hardware-based system that performs specified functions or operations, or may be implemented by a combination of dedicated hardware and computer instructions.

The modules involved in the embodiments of the present disclosure may be implemented in software or hardware. The name of the module does not constitute a limitation on the module itself under certain circumstances.

The functions described above herein may be performed, at least in part, by one or more hardware logic components. For example, without limitation, exemplary types of hardware logic components that can be used include: field programmable gate array (FPGA), application specific integrated circuit (ASIC), application specific standard product (ASSP), system on chip (SOC), complex programmable logic device (CPLD) and so on.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description is only preferred embodiments of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or their equivalents without departing from the above disclosed concept, for example, a technical solution formed by replacing the above features with the technical features having similar functions disclosed in the present disclosure (but not limited to).

In addition, although various operations are depicted in a specific order, this should not be understood as requiring these operations to be performed in the specific order shown or in a sequential order. Under certain circumstances, multitasking and parallel processing may be advantageous. Likewise, although several specific implementation details are contained in the above discussion, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the methods, it should be understood that the subject matter defined in the appended claims is not necessarily limited to the specific features or actions described above. Rather, the specific features and actions described above are merely example forms of implementing the claims. Regarding the apparatus in the above embodiments, the specific manner in which each module performs operations has been described in detail in the method embodiments, and will not be described in detail here. CLAIMS

1. A data analysis method, comprising:
displaying, in a first data analysis platform, a data graph to be analyzed or a data table to be analyzed;
in response to a trigger operation on a content displayed in the data graph or the data table, displaying a data panel, and displaying, in the data panel, a function entry for jumping from the first data analysis platform to a second data analysis platform; and
in response to a trigger operation on the function entry, jumping from the first data analysis platform to the second data analysis platform.

2. The data analysis method according to claim 1, wherein in response to the trigger operation on the content displayed in the data graph, displaying the data panel, and displaying, in the data panel, the function entry for jumping from the first data analysis platform to the second data analysis platform comprises:
in response to a trigger operation on a data point or a data region in the data graph, displaying the data panel, and displaying a first interaction control in the data panel; and
in response to a trigger operation on the first interaction control, displaying, in the data panel, the function entry for jumping from the first data analysis platform to the second data analysis platform.

3. The data analysis method according to claim 1, wherein in response to the trigger operation on the content displayed in the data table, displaying the data panel, and displaying, in the data panel, the function entry for jumping from the first data analysis platform to the second data analysis platform comprises:
in response to a trigger operation on a data item in the data table or a second interaction control, displaying the data panel, and displaying, in the data panel, the function entry for jumping from the first data analysis platform to the second data analysis platform.

4. The data analysis method according to claim 1, further comprising:
displaying, in the data panel, a target content related to the display content, wherein the target content comprises data information corresponding to the display content and/or a function option for performing data processing on data information corresponding to the display content.

5. The data analysis method according to claim 4, wherein when display contents in the data graph or the data table are different, target contents displayed in the data panel are different; and/or
when a trigger operation is performed on different display contents in the data graph or the data table, target contents displayed in the data panel are different.

6. The data analysis method according to claim 5, wherein displaying, in the data panel, the target content related to the display content comprises:
displaying, in the data panel, the data information corresponding to the display content and the function option for performing the data processing on the data information corresponding to the display content; or
displaying, in the data panel, at least one selected from a group consisting of: the data information corresponding to the display content, the function option for performing the data processing on the data information corresponding to the display content, or comparison information of the data information corresponding to the display content in a time dimension; or
displaying, in the data panel, at least one selected from a group consisting of: the data information corresponding to the display content, the function option for performing the data processing on the data information corresponding to the display content, comparison information of the data information corresponding to the display content in a time dimension, or at least one piece of sub-dimensional information of the data information corresponding to the display content in a target data dimension, wherein the target data dimension is a data dimension corresponding to the data information.

7. The data analysis method according to claim 5, wherein displaying, in the data panel, the target content related to the display content comprises:
in response to a trigger operation on a first display content, displaying a first target content related to the first display content; and
in response to a trigger operation on a second display content, displaying a second target content related to the second display content, wherein the first display content is different from the second display content.

8. The data analysis method according to claim 4, wherein the target content and the function entry displayed in the data panel are displayed through an identical preset display style.

9. A non-transitory computer-readable medium storing a computer program, wherein the computer program, when executed by a processing apparatus, causes the processing apparatus to implement a data analysis method, and the method comprises:
displaying, in a first data analysis platform, a data graph to be analyzed or a data table to be analyzed;
in response to a trigger operation on a content displayed in the data graph or the data table, displaying a data panel, and displaying, in the data panel, a function entry for jumping from the first data analysis platform to a second data analysis platform; and
in response to a trigger operation on the function entry, jumping from the first data analysis platform to the second data analysis platform.

10. The non-transitory computer-readable medium according to claim 9, wherein in response to the trigger operation on the content displayed in the data graph, displaying the data panel, and displaying, in the data panel, the function entry for jumping from the first data analysis platform to the second data analysis platform comprises:
in response to a trigger operation on a data point or a data region in the data graph, displaying the data panel, and displaying a first interaction control in the data panel; and
in response to a trigger operation on the first interaction control, displaying, in the data panel, the function entry for jumping from the first data analysis platform to the second data analysis platform.

11. The non-transitory computer-readable medium according to claim 9, wherein in response to the trigger operation on the content displayed in the data table, displaying the data panel, and displaying, in the data panel, the function entry for jumping from the first data analysis platform to the second data analysis platform comprises:
in response to a trigger operation on a data item in the data table or a second interaction control, displaying the data panel, and displaying, in the data panel, the function entry for jumping from the first data analysis platform to the second data analysis platform.

12. The non-transitory computer-readable medium according to claim 9, wherein the method further comprises:
displaying, in the data panel, a target content related to the display content, wherein the target content comprises data information corresponding to the display content and/or a function option for performing data processing on data information corresponding to the display content.

13. The non-transitory computer-readable medium according to claim 12, wherein when display contents in the data graph or the data table are different, target contents displayed in the data panel are different; and/or
when a trigger operation is performed on different display contents in the data graph or the data table, target contents displayed in the data panel are different.

14. The non-transitory computer-readable medium according to claim 13, wherein displaying, in the data panel, the target content related to the display content comprises:
displaying, in the data panel, the data information corresponding to the display content and the function option for performing the data processing on the data information corresponding to the display content; or
displaying, in the data panel, at least one selected from a group consisting of: the data information corresponding to the display content, the function option for performing the data processing on the data information corresponding to the display content, or comparison information of the data information corresponding to the display content in a time dimension; or
displaying, in the data panel, at least one selected from a group consisting of: the data information corresponding to the display content, the function option for performing the data processing on the data information corresponding to the display content, comparison information of the data information corresponding to the display content in a time dimension, or at least one piece of sub-dimensional information of the data information corresponding to the display content in a target data dimension, wherein the target data dimension is a data dimension corresponding to the data information.

15. The non-transitory computer-readable medium according to claim 13, wherein displaying, in the data panel, the target content related to the display content comprises:
in response to a trigger operation on a first display content, displaying a first target content related to the first display content; and
in response to a trigger operation on a second display content, displaying a second target content related to the second display content, wherein the first display content is different from the second display content.

16. The non-transitory computer-readable medium according to claim 12, wherein the target content and the function entry displayed in the data panel are displayed through an identical preset display style.

17. An electronic device, comprising:
a storage apparatus, configured to store a computer program; and
a processing apparatus, configured to execute the computer program in the storage apparatus to implement a data analysis method, wherein the method comprises:
displaying, in a first data analysis platform, a data graph to be analyzed or a data table to be analyzed;
in response to a trigger operation on a content displayed in the data graph or the data table, displaying a data panel, and displaying, in the data panel, a function entry for jumping from the first data analysis platform to a second data analysis platform; and
in response to a trigger operation on the function entry, jumping from the first data analysis platform to the second data analysis platform.

18. The electronic device according to claim 17, wherein in response to the trigger operation on the content displayed in the data graph, displaying the data panel, and displaying, in the data panel, the function entry for jumping from the first data analysis platform to the second data analysis platform comprises:
in response to a trigger operation on a data point or a data region in the data graph, displaying the data panel, and displaying a first interaction control in the data panel; and
in response to a trigger operation on the first interaction control, displaying, in the data panel, the function entry for jumping from the first data analysis platform to the second data analysis platform.

19. The electronic device according to claim 17, wherein in response to the trigger operation on the content displayed in the data table, displaying the data panel, and displaying, in the data panel, the function entry for jumping from the first data analysis platform to the second data analysis platform comprises:
in response to a trigger operation on a data item in the data table or a second interaction control, displaying the data panel, and displaying, in the data panel, the function entry for jumping from the first data analysis platform to the second data analysis platform.

20. The electronic device according to claim 17, wherein the method further comprising:
displaying, in the data panel, a target content related to the display content, wherein the target content comprises data information corresponding to the display content and/or a function option for performing data processing on data information corresponding to the display content.
